(19) United States
(12) Patent Application Publication
(10) Pub. No.: US 2013/0047843 A1
(43) Pub. Date: Feb. 28, 2013

(54) Metal Organic Framework Filled Polymer Based Membranes

(71) Applicants: Scott T. Matteucci, Midland, MI (US); Leonardo C. Lopez, Midland, MI (US); Shawn D. Feist, Midland, MI (US); Peter N. Nickias, Midland, MI (US); Dean M. Millar, Midland, MI (US); Michael P. Tate, Midland, MI (US)

(72) Inventors: Scott T. Matteucci, Midland, MI (US); Leonardo C. Lopez, Midland, MI (US); Shawn D. Feist, Midland, MI (US); Peter N. Nickias, Midland, MI (US); Dean M. Millar, Midland, MI (US); Michael P. Tate, Midland, MI (US)

(73) Assignee: DOW GLOBAL TECHNOLOGIES LLC, Midland, MI (US)

(21) Appl. No.: 13/577,577

(22) PCT Filed: Feb. 11, 2011
(86) PCT No.: PCT/US11/24448

§ 371 Date: Sep. 6, 2012

Related U.S. Application Data
(60) Provisional application No. 61/304,109, filed on Feb. 12, 2010.

(51) Int. Cl. C08L 77/12; B01D 53/22; C08L 75/06

(52) U.S. Cl. 95/45; 521/27

(57) ABSTRACT

A membrane for separation of gases, the membrane including a metal-organic phase and a polymeric phase, the metal-organic phase having porous crystalline metal compounds and ligands, the polymeric phase having a molecularly self assembling polymer.

### FIELD OF THE INVENTION

The invention generally relates to membrane technology. More specifically, the invention relates to composite membranes used in gas separation applications.

### BACKGROUND OF THE INVENTION

The separation of gases is an important process in industry. Membranes have traditionally been a viable method for conducting certain separations such as air separations, N₂/H₂, and natural gas sweetening. In addition to these applications, many other applications will become economically viable if the membrane selective layer permeability increases without significant loss of selectivity. Thus, improvement in permeability is likely to be well received by customers and open new areas to membrane technologies where the membrane capital cost was considered prohibitive.

Unfortunately, engineering viable, high-permeability polymer based membranes with economically viable selectivities has proven difficult. It is well known that altering polymer structure to increase permeability may result in loss of selectivity. Therefore many groups have turned to so-called “mixed matrix membranes” where an inorganic phase is used to improve permeability and/or selectivity. Although there have been glimmers of success, most polymer-inorganic phases suffer from incompatibility or dewetting issues that impede rather than improve membrane performance.

For example, Ekiner et al., U.S. Pat. No. 7,422,623, titled Separation Membrane by Controlled Annealing of Polyimide Polymers teaches a membrane that is comprised of a polyimide. The polymer is annealed in order to give the membrane greater selectivity stability during operation. Further, Yaghi, et al., US2007/0068389, titled Metal-Organic Frameworks with Exceptionally High Capacity For Storage of Carbon Dioxide at Room Temperature teaches zinc terephthalate salt frameworks and their aminated analogs for adsorption of carbon dioxide. The carbon dioxide adsorptive capacity of the non-aminated, and fully aminated material is disclosed. Yaghi does not describe a partially aminated material.

Freeman et al., U.S. Pat. No. 7,510,595, titled Metal Oxide Nanoparticles filled Polymers teaches the use of metal and metal oxide nanoparticles as a method for increasing permeability while maintaining native polymer selectivity properties. Disclosed polymers include polyethylene oxide, poly(1-trimethylsilyl-1-propyne), and 1,2-polybutadiene. The nanoparticles range in size from 1.0 to 500 nm in primary particle diameter.

Funk and Lloyd, WO2008112745, titled High Selectivity Polymer-Nano-Porous Particle Membrane Structures discloses polymer membranes formed of nano-porous materials. The claims mention metal organic frameworks (MOF)s without any further description, but most of the claims around the particles involve zeolites.

Fritsch et al., US20060230926, titled Composite Material, especially Composite Membrane and Process of Manufacture discloses mixed matrix membrane for gas separations. Metal organic frameworks are identified as a second polymeric material added to the matrix.

None of these disclosures provide polymers which are macromolecularly self assembling while providing desirable gas transport properties for example selectivity and permeability, easy processability and wet embedding of particles.

### SUMMARY OF THE INVENTION

Metal organic framework or “MOF” materials are solid materials with an open pore structure that contain very high surface areas. By themselves, MOFs have been demonstrated to have very high gas sorption capacities, which suggest that gases will diffuse readily through MOFs if incorporated into a membrane. By dispersing MOFs into polymers with demonstrated high selectivities such as macromolecular self-assembling (MSA) polyesteramides, permeabilities increased substantially compared to MSA alone even at low particle loadings, while commercially relevant selectivities are still present in the composite.

In accordance with one aspect of the invention, there is provided a membrane for separation of gases comprising a metal-organic phase and a polymeric phase. The metal-organic phase comprises porous crystalline metal compounds and ligands. The polymeric phase comprises a molecularly self assembling polymer.

The invention comprises membranes and films of macromolecular self-assembling polymers filled with metal organic frameworks that allow for preferential separation of target gases. The filled polymers have a substantially higher permeability than the unfilled polymers because the filler is highly porous. The polymer adheres to the metal organic framework so as to maintain pure gas selectivities that are similar to those of the unfilled polymer.

Compositions of the invention have high pure gas CO₂ permeability (flux) and high mixed gas CO₂/CH₄ selectivities.

### DETAILED DESCRIPTION OF THE PREFERRED EMBODIMENTS

The invention is a membrane for the separation of acidic gases such as SO₂ and CO₂ from non-polar gases such as N₂, CH₄, H₂, or C₂H₄. The membrane includes a metal-organic phase and a polymeric phase. The metal-organic phase comprises porous crystalline metal compounds and ligands. The polymeric phase comprises a molecularly self assembling polymer.

### Molecularly Self Assembling Polymer

As used herein, an MSA material means an oligomer or polymer that effectively forms larger associated or assembled oligomers and/or high polymers through the physical intermolecular associations of chemical functional groups. Without wishing to be bound by theory, it is believed that the intermolecular associations do not increase the molecular weight (Mn-Number Average molecular weight) or chain length of the self-assembling material and covalent bonds between the materials do not form.

This combining or assembling occurs spontaneously upon a triggering event such as cooling to form the larger associated or assembled oligomer or polymer structures. Examples of other triggering events are the shear-induced crystallizing of, and contacting a nucleating agent to, a molecularly self-assembling material. Accordingly, in preferred embodiments, MSA's exhibit mechanical properties similar to some higher molecular weight synthetic polymers and viscosities like very low molecular weight compounds. MSA organization (self-assembly) is caused by non-covalent bonding interactions, often directional, between molecular functional groups or moieties located on individual molecular (i.e., oligomer or polymer) repeat units (e.g., hydrogen-bonded arrays). Non-covalent bonding interactions include: electrostatic interactions (ion-ion, ion-dipole or dipole-dipole), coordinative metal-ligand bonding, hydrogen bonding, π-π-structure stacking interactions, donor-acceptor, and/or Van der Waals forces and can occur intra- and intermolecularly to impart structural order.

One preferred mode of self-assembly is hydrogen-bonding and this non-covalent bonding interactions is defined by a mathematical “Association constant,” K(assoc) constant describing the relative energetic interaction strength of a chemical complex or group of complexes having multiple hydrogen bonds. Such complexes give rise to the higher-ordered structures in a mass of MSA materials. A description of self assembling multiple H-bonding arrays can be found in “Supramolecular Polymers,” Alberto Ciferri Ed., 2nd Edition, pages (pp) 157-158.

A “hydrogen bonding array” is a purposely synthesized set (or group) of chemical moieties (e.g., carbonyl, amine, amide, hydroxyl, etc.) covalently bonded on repeating structures or units to prepare a self assembling molecule so that the individual chemical moieties preferably form self assembling donor-acceptor pairs with other donors and acceptors on the same, or different, molecule. A “hydrogen bonded complex” is a chemical complex formed between hydrogen bonding arrays. Hydrogen bonded arrays can have association constants K (assoc) between 10² and 10⁹ M⁻¹ (reciprocal molarities), generally greater than 10³ M⁻¹. In preferred embodiments, the arrays are chemically the same or different and form complexes.

Accordingly, the molecularly self-assembling materials (MSA) suitable for us in the invention include molecularly self-assembling polyesteramides, copolyesteramide, copolyetherester-amide, copolyetheramide, copolyetherester-amide, copolyetherester-urethane, copolyether-urethane, copolyester-urethane, copolyester-urea, copolyetherester-urea and their mixtures. Preferred MSA include copolyesteramide, copolyether-amide, copolyester-urethane, and copolyether-urethanes. The MSA preferably has number average molecular weights, MWₙ (interchangeably referred to as Mₙ) (as is preferably determined by NMR spectroscopy or optionally gel permeation chromotography (GPC)) of 200 grams per mole or more, more preferably at least about 3000 g/mol, and even more preferably at least about 5000 g/mol. The MSA preferably has MWₙ 1,000,000 g/mol or less, more preferably about 50,000 g/mol or less, yet more preferably about 20,000 g/mol or less, and even more preferably about 12,000 g/mol or less.

The MSA material preferably comprises molecularly self-assembling repeat units, more preferably comprising (multiple) hydrogen bonding arrays, wherein the arrays have an association constant K (assoc) preferably from 102 to 109 reciprocal molarity (M−1) and still more preferably greater than 103 M−1; association of multiple-hydrogen-bonding arrays comprising donor-acceptor hydrogen bonding moieties is the preferred mode of self assembly. The multiple H-bonding arrays preferably comprise an average of 2 to 8, more preferably 4-6, and still more preferably at least 4 donor-acceptor hydrogen bonding moieties per molecularly self-assembling unit. Molecularly self-assembling units in preferred MSA materials include bis-amide groups, and bis-urethane group repeat units and their higher olgomers.

Preferred self-assembling units in the MSA material useful in the present invention are bis-amides, bis-urethanes and bis-urea units or their higher oligomers. For convenience and unless stated otherwise, oligomers or polymers comprising the MSA materials may simply be referred to herein as polymers, which includes homopolymers and interpolymers such as co-polymers, terpolymers, etc.

In some embodiments, the MSA materials include “non-aromatic hydrocarbylene groups” and this term means specifically herein hydrocarbylene groups (a divalent radical formed by removing two hydrogen atoms from a hydrocarbon) not having or including any aromatic structures such as aromatic rings (e.g., phenyl) in the backbone of the oligomer or polymer repeating units. In some embodiments, non-aromatic hydrocarbylene groups are optionally substituted with various substituents, or functional groups, including but not limited to: halides, alkoxy groups, hydroxyl groups, thiol groups, ester groups, ketone groups, carboxylic acid groups, amines, and amides. A “non-aromatic heterohydrocarbylene” is a hydrocarbylene that includes at least one non-carbon atom (e.g., N, O, S, P or other heteroatom) in the backbone of the polymer or oligomer chain, and that does not have or include aromatic structures (e.g., aromatic rings) in the backbone of the polymer or oligomer chain.

In some embodiments, non-aromatic heterohydrocarbylene groups are optionally substituted with various substituents, or functional groups, including but not limited to: halides, alkoxy groups, hydroxyl groups, thiol groups, ester groups, ketone groups, carboxylic acid groups, amines, and amides. Heteroalkylene is an alkylene group having at least one non-carbon atom (e.g., N, O, S or other heteroatom) that, in some embodiments, is optionally substituted with various substituents, or functional groups, including but not limited to: halides, alkoxy groups, hydroxyl groups, thiol groups, ester groups, ketone groups, carboxylic acid groups, amines, and amides. For the purpose of this disclosure, a “cycloalkyl” group is a saturated carbocyclic radical having three to twelve carbon atoms, preferably three to seven. A “cycloalkylene” group is an unsaturated carbocyclic radical having three to twelve carbon atoms, preferably three to seven. Cycloalkyl and cycloalkylene groups independently are monocyclic or polycyclic fused systems as long as no aromatics are included. Examples of carbocylclic radicals include cyclopropyl, cyclobutyl, cyclopentyl, cyclohexyl and cycloheptyl.

In some embodiments, the groups herein are optionally substituted in one or more substitutable positions as would be known in the art. For example in some embodiments, cycloalkyl and cycloalkylene groups are optionally substituted with, among others, halides, alkoxy groups, hydroxyl groups, thiol groups, ester groups, ketone groups, carboxylic acid groups, amines, and amides. In some embodiments, cycloalkyl and cycloalkene groups are optionally incorporated into combinations with other groups to form additional substituent groups, for example: “-Alkylene-cycloalkylene-,” “-alkylene-cycloalkylene-alkylene-,” “heteroalkylene-cycloalkylene-,” and “-heteroalkylene-cycloalkyl-heteroalkylene” which refer to various non-limiting combinations of alkyl, heteroalkyl, and cycloalkyl. These combinations include groups such as oxydialkylenes (e.g., diethylene glycol), groups derived from branched diols such as neopentyl glycol or derived from cyclo-hydrocarbylene diols such as Dow Chemical's UNOXOL® isomer mixture of 1,3- and 1,4-cyclohexanedimethanol, and other non-limiting groups, such -methylcylohexyl-methyl-cyclohexyl-methyl-, and the like.

“Heterocycloalkyl” is one or more cyclic ring systems having 4 to 12 atoms and, containing carbon atoms and at least one and up to four heteroatoms selected from nitrogen, oxygen, or sulfur. Heterocycloalkyl includes fused ring structures. Preferred heterocyclic groups contain two ring nitrogen atoms, such as piperazinyl. In some embodiments, the heterocycloalkyl groups herein are optionally substituted in one or more substitutable positions. For example in some embodiments, heterocycloalkyl groups are optionally substituted with halides, alkoxy groups, hydroxyl groups, thiol groups, ester groups, ketone groups, carboxylic acid groups, amines, and amides.

Examples of MSA materials useful in the present invention are poly(ester-amides), poly(ether-amides), poly(ester-ureas), poly(ether-ureas), poly(ester-urethanes), and poly(ether-urethanes), and mixtures thereof that are described, with preparations thereof, in U.S. Pat. No. 6,172,167; and applicant's co-pending PCT application numbers PCT/US2006/023450, which was renumbered as PCT/US2006/004005 and published under PCT International Patent Application Number (PCT-IPAPN) WO 2007/099397; PCT/US2006/035201, which published under PCT-IPAPN WO 2007/030791; PCT/US08/053,917; PCT/US08/056,754; and PCT/US08/065,242. Preferred said MSA materials are described below.

In a set of preferred embodiments, the molecularly self-assembling material comprises ester repeat units of Formula I:

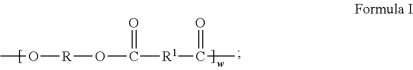

and at least one second repeat unit selected from the esteramide units of Formula II and III.

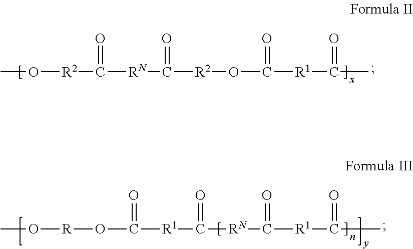

and the ester urethane units of Formula IV:

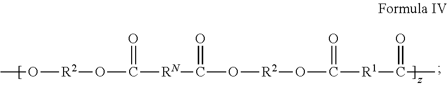

wherein R is at each occurrence, independently a C₂-C₂₀ non-aromatic hydrocarbylene groups, a C₂-C₂₀ non-aromatic heterohydrocarbylene groups, or a polyalkylene oxide group having a group molecular weight of from about 100 to about 15000 g/mol. In a preferred embodiments, the C₂-C₂₀ non-aromatic hydrocarbylene at each occurrence is independently specific groups: alkylene-, -cycloalkylene-, -alkylene-cycloalkylene-, -alkylene-cycloalkylene-alkylene-(including dimethylene cyclohexyl groups).

Preferably, these aforementioned specific groups are from 2 to 12 carbon atoms, more preferably from 3 to 7 carbon atoms. The C₂-C₂₀ non-aromatic heterohydrocarbylene groups are at each occurrence, independently specifically groups, non-limiting examples including: -hetereoalkylene-, -heteroalkylene-cycloalkylene-, cycloalkylene-heteroalkylene-, or -heteroalkylene-cycloalkylene-heteroalkylene-, each aforementioned specific group preferably comprising from 2 to 12 carbon atoms, more preferably from 3 to 7 carbon atoms. Preferred heteroalkylene groups include oxydialkylenes, for example diethylene glycol (—CH₂CH₂OCH₂CH₂—O—). When R is a polyalkylene oxide group it preferably is a polytetramethylene ether, polypropylene oxide, polyethylene oxide, or their combinations in random or block configuration wherein the molecular weight (Mn-average molecular weight, or conventional molecular weight) is preferably about 250 g/ml to 5000, g/mol, more preferably more than 280 g/mol, and still more preferably more than 500 g/mol, and is preferably less than 3000 g/mol; in some embodiments, mixed length alkylene oxides are included. Other preferred embodiments include species where R is the same C₂-C₆ alkylene group at each occurrence, and most preferably it is —(CH₂)₄—.

R¹ is at each occurrence, independently, a bond, or a C₁-C₂₀ non-aromatic hydrocarbylene group. In some preferred embodiments, R¹ is the same C₁-C₆ alkylene group at each occurrence, most preferably —(CH₂)₄—.

R² is at each occurrence, independently, a C₁-C₂₀ non-aromatic hydrocarbylene group. According to another embodiment, R² is the same at each occurrence, preferably C₁-C₆ alkylene, and even more preferably R² is —(CH₂)₂—, —(CH₂)₃—, —(CH₂)₄—, or —(CH₂)₅—.

R^{N} is at each occurrence —N(R³)—Ra—N(R³)—, where R³ is independently H or a C₁-C₆ alkyl, preferably C₁-C₄ alkyl, or R^{N} is a C₂-C₂₀ heterocycloalkylene group containing the two nitrogen atoms, wherein each nitrogen atom is bonded to a carbonyl group according to Formula II or III above, w represents the ester mol fraction, and x, y, and z represent the amide or urethane mole fractions where w+x+y+z=1, 0<w<1, and at least one of x, y and z is greater than zero. n is at least 1 and has a mean value less than 2. Ra is a C₂-C₂₀ non-aromatic hydrocarbylene group, more preferably a C₂-C₁₂ alkylene: most preferred Ra groups are ethylene butylene, and hexylene —(CH₂)₆—. In some embodiments, R^{N} is piperazin-1,4-diyl. According to another embodiment, both R³ groups are hydrogen.

In an alternative embodiment, the MSA is a polymer of repeating units of either Formula II or Formula III, where R, R², R^{N}, and n are as defined above and x and y are mole fractions wherein x+y=1, and 0<x<1 and 0<y<1.

In certain embodiments comprising polyesteramides of Formula I and II, or Formula I, II, and III, particularly preferred materials are those wherein R is —(C₂-C₆)-alkylene, especially —(CH₂)₄—. Also preferred are materials wherein R¹ at each occurrence is the same and is C₁-C₆ alkylene, especially —(CH₂)₄—. Further preferred are materials wherein R² at each occurrence is the same and is —(C₁-C₆)-alkylene, especially —(CH₂)₅— alkylene. The polyesteramide according to this embodiment preferably has a number average molecular weight (Mn) of at least about 4000, and no more than about 20,000. More preferably, the molecular weight is no more than about 12,000.

For convenience the repeating units for various embodiments are shown independently. The invention encompasses all possible distributions of the w, x, y, and z units in the copolymers, including randomly distributed w, x, y, and z units, alternatingly distributed w, x, y and z units, as well as partially, and block or segmented copolymers, the definition of these kinds of copolymers being used in the conventional manner as known in the art. Additionally, there are no particular limitations in the invention on the fraction of the various units, provided that the copolymer contains at least one w and at least one x, y, or z unit. In some embodiments, the mole fraction of w to (x+y+z) units is between about 0.1:0.9 and about 0.9:0.1. In some preferred embodiments, the copolymer comprises at least 15 mole percent w units, at least 25 mole percent w units, or at least 50 mole percent w units.

In some embodiments, the number average molecular weight (Mₙ) of the MSA material useful in the present invention is between 1000 g/mol and 50,000 g/mol, inclusive. In some embodiments, Mᵣ, of the MSA material is between 2,000 g/mol and 25,000 g/mol, inclusive, preferably 5,000 g/mol to 12,000 g/mol. In more preferred embodiments, Mₙ of the MSA material is less than 5,000 g/mol.

### Metal Organic Structure

The composition of the invention comprises a porous metal organic structure generally comprising one or more type of ligands and one or more types of metals. These materials are a porous ordered three-dimensional structures.

### Metals

Generally the metals useful in the metal-organic structure of the invention include those which produce the interaction with any variety of organic structures towards the formation of a porous network. The metal must have sufficiently strong interactions with the ligands such that a porous three-dimensional structure can form. Preferred metals include transition metals or metalloids selected from the group consisting of Scandium, Titanium, Vanadium, Chromium, Manganese, Magnesium, Cobalt, Iron, Nickel, Copper, Zinc, Yttrium, Zirconium, Niobium, Molybdenum, Ruthenium, Rhodium, Palladium, Silver, Cadmium, Lanthanum, Hafnium, Tantalum, Tungsten, Rhenium, Osmium, Iridium, Gold, Aluminum, Indium, Lead, Tin, Gallium, Germanium, Bismuth, Polonium, and mixtures thereof. Most preferred metals include Aluminum, Indium, Nickel, Zinc, and mixtures thereof.

### Ligand

The ligand functions to assist in forming the metal-organic phase which is a porous network. Useful ligands include those capable of forming cationic, anionic or neutral complexes. The complexes formed may be homoleptic or heteroleptic in nature. Said ligands must interact with the metal in such a manner that allows for formation of a porous three-dimensional structure.

Useful ligands may be bidentate, tridentate, or multidentate. A nonlimiting list of ligands includes dicarboxylic acids; dianhydrides; diimides; substituted dicarboxylic acids; substituted diamines; and disubstituted cycloamines; imidazoles, and mixtures thereof. Dicarboxylic acids include oxalic acids, malonic acids, succinic acids, glutaric acids, adipic acids, pimelic acids, terephthalic acids and suberic acids among other including their amine and diamine derivatives. Also useful are amines such as substituted diamines, for example ethyl, propyl, butyl, pentyl, hexyl, heptyl, octyl, nonyl, and decyl disubstituted amines among others. Disubstituted cycloamines are also useful in the composition of the invention such as 1,4-diazobicyclo(2,2,2)octane among others.

Preferred ligands include terephthalic acid, 1,4-diazobicyclo(2,2,2)octane, 2-aminoterephthalic acid, 2-methylimidazole and mixtures thereof.

Optionally, the ligands may contain pendent groups in order to define structure or improve gas MOF interactions. A non-limiting list of pendent groups includes: amines, nitriles and ethers. Amines are the preferred pendent group.

Representative gas streams to which the invention may be applied include biogas streams, flue/exhaust gas streams and well head gas streams among others.

The metal organic frame work, once formulated, comprises a three dimensional porous network into which penetrant gases permeate. Generally pore size for the framework may be at least about 1 angstrom up to about 20 angstroms. Preferably pore size may be about 3 angstroms up to about 15 angstoms.

Generally, two properties, permeability and selectivity are important for the composition of the invention. Permeability is generally reported in terms of barrer, where barrer is defined as:

1 barrer=10⁻¹⁰ cm³(STP)cm/(cm²s (cm Hg))

Permeability is a material property of a matrix and a gas. As such it is possible to define a materials performance by permeability. For many current applications of membranes preferred membranes would require high CO₂ permeability. A characteristic of materials in this application is that the filled polymer system will have a permeability that is higher than the unfilled polymer at the same testing conditions.

Ideal gas selectivity is defined as the pure gas permeability of gas A divided by the pure gas permeability of gas B. MSA based polymers generally have sufficient selectivities for many applications. In many cases the selectivity is higher than what is required for the practice of these separations, as such is it acceptable if the membrane suffers a small loss in selectivity if it is sacrificed for an increase in permeability. There losses of CO₂/N₂ or CO₂/CH₄ selectivities of up to 80% can be acceptable with increased permeability as long as the membrane still can meet purity requirements within the use of the membrane material.

Acid gas, that is CO₂ or SO₂, permeability is generally at least about 30 barrer, preferably up to generally above about 40 barrer, preferably above about 50 barrer, and more preferably above about 80 barrer, at the temperature and acid gas partial pressures of use. Acid gas/non-polar gas selectivity depends on the gas sought but generally is at least about 6, preferably at least about 8, and more preferably at least about 12 at the temperature and acid gas partial pressures of use. For example CO₂ permeability 49.8 barrer and CO₂/N₂ selectivity of 23.4 at 35° C. and CO₂ feed pressure of 15 psig.

Representative substrates include any material useful with separation membranes including any symmetric or asymmetric hollow fiber material, and dense fiber spiral wound materials, among others. Useful substrates and modules include those disclosed in U.S. Pat. No. 5,486,430 issued Jan. 23, 1996; WO 2008/150586 published Dec. 11, 2008; and WO 2009/125217 published Oct. 15, 2009, all of which are incorporated herein by reference.

In the composite of the invention, the metal organic phase may comprise at least about 1 wt-%, preferably about 5 wt-%, and more preferably 10 wt-% metal organic with an upper concentration of no more than about 70 wt-%, preferably no more than 50 wt-%, and more preferably no more than 30 wt-% metal organic, the balance of the composite comprising polymer.

### WORKING EXAMPLES

The following Examples provided a nonlimiting illustration of various embodiments of the invention.

### Polymer Preparation

Preparation 1: preparation of MSA material that is a polyesteramide (PEA) comprising about 18 mole percent of ethylene-N,N′-dihydroxyhexanamide (C2C) monomer (the MSA material is generally designated as a PEA-C2C18%)

The following preparation is designed to give a PEA comprising 18 mol % of the C2C monomer. Into a 1-neck 500 mL round bottom flask is loaded titanium (IV) butoxide (0.31 g, 0.91 mmol), N,N′-1,2-ethanediyl-bis[6-hydroxyhexanamide] (C2C, 30.80 g, 0.1068 mol), dimethyl adipate (103.37 g, 0.5934 mol), and 1,4-butanediol (97.33 g, 1.080 mol). A stir-shaft and blade are inserted into the flask along with a modified Claisen adaptor with Vigreux column and distillation head. Apparatus is completed with stir bearing, stir motor, thermometer, take-off adaptor, receiver, heat-tracing and insulation, vacuum pump, vacuum regulator, nitrogen feed, and temperature controlled bath. Apparatus is degassed and held under positive nitrogen. Flask is immersed into a 160° C. bath with temperature raised to 175° C. for a total of 2 hours. Receiver is changed and vacuum is applied according to the following schedule: 5 minutes, 450 Torr (60 kiloPascals (kPa)); 5 minutes, 100 Torr; 5 minutes, 50 Torr; 5 minutes, 40 Torr; 10 minutes, 30 Ton; 10 minutes, 20 Torr; 1.5 hours, 10 Torr. Apparatus is placed under nitrogen, receiver changed, and placed under vacuum ranging over about 0.36 Torr to 0.46 Torr with the following schedule: 2 hours, 175° C.; 2 hours, to/at 190° C., and 3 hours to/at 210° C. Inherent viscosity=0.32 dL/g (methanol:chloroform (1:1 w/w), 30.0° C., 0.5 g/dL) to give the PEA-C2C18% of Preparation 1. By proton NMR in d4-acetic acid, Mn from end groups of the PEA-C2C18% of Preparation 1 is 11,700 g/mol. The PEA-C2C18% of Preparation 1 contains 17.3 mole % of polymer repeat units contain C2C.

Proton nuclear magnetic resonance spectroscopy (proton NMR or ¹H-NMR) is used to determine monomer purity, copolymer composition, and copolymer number average molecular weight Mₙ utilizing the CH₂OH end groups. Proton NMR assignments are dependent on the specific structure being analyzed as well as the solvent, concentration, and temperature utilized for measurement. For ester amide monomers and co-polyesteramides, D₄-acetic acid is a convenient solvent and is the solvent used unless otherwise noted. For ester amide monomers of the type called DD that are methyl esters typical peak assignments are about 3.6 to 3.7 ppm for C(═O)—OCH₃; about 3.2 to 3.3 ppm for N—CH₂—; about 2.2 to 2.4 ppm for C(═O)—CH₂—; and about 1.2 to 1.7 ppm for C—CH₂—C. For co-polyesteramides that are based on DD with 1,4 butanediol, typical peak assignments are about 4.1 to 4.2 ppm for C(═O)—OCH₂—; about 3.2 to 3.4 ppm for N—CH₂—: about 2.2 to 2.5 ppm for C(═O)—CH₂—; about 1.2 to 1.8 ppm for C—CH₂—C, and about 3.6 to 3.75 —CH₂OH end groups. Proton NMR determines that Sample Numbers 1 to 3 have Mₙ of 6450 grams per mole (g/mol); 6900 g/mol; and 7200 g/mol, respectively.

### MOF-1

MOF-1 is a commercially available metal organic framework comprised of 2-Methylimidazole zinc salt (Sigma Aldrich).

### MOF-2

MOF-2 has a different ligand and metal formulation than MOF-1. This material is an example of a different structural configuration than what is present in MOF-1. Nickel(II) nitrate hexahydrate, 0.61 g (2.10 mmol), were dissolved in 15 mL dimethylformamide. Separately, 0.16 g 1,4-diazobicyclo(2,2,2)octane (1.42 mmol), 0.16 g (0.86 mmol) 2-aminoterephthalic acid and 0.14 g (0.86 mmol) terephthalic acid were dissolved in 15 mL dimethylformamide. The two solutions were combined in a 45 mL teflon-lined reactor, sealed and placed in a 130° C. oven for 3 days. After quenching, reactor contents were poured into a centrifuge tube and spun for 10 minutes at 10,000 rpm, decanted, washed two times by resuspending in 25 mL acetone, centrifuging as before and decanting. Final solids were collected and dried at 70° C.

Calcination was performed on a 0.75 g aliquot of the combined solids by treating the solids in an air-purged furnace, ramping from ambient temperature to 300° C. over 2 hours and holding at 300° C. for 4 hours before allowing to slowly cool to ambient temperature.

### MOF-3

Nickel(II) nitrate hexahydrate, 0.61 g (2.10 mmol), were dissolved in 15 mL dimethylformamide. Separately, 0.16 g 1,4-diazobicyclo(2,2,2)octane (1.42 mmol), 0.16 g (0.86 mmol) 2-aminoterephthalic acid and 0.14 g (0.86 mmol) terephthalic acid were dissolved in 15 mL dimethylformamide. The two solutions were combined in a 45 mL teflon-lined reactor, sealed and placed in a 130° C. oven for 3 days. After quenching, reactor contents were poured into a centrifuge tube and spun for 10 minutes at 10,000 rpm, decanted, washed two times by resuspending in 25 mL acetone, centrifuging as before and decanting. Final solids were collected and dried at 70° C.

### MOF-4

MOF-4 has a different ligand and metal formulation than MOF-1 or MOF-2. This material is an example of a different structural configuration than what is present in MOF-1 or MOF-2. These MOF structures are non-limiting examples of MOF and MOF structures that can be used in this invention. This material also contains a pendent amine group, which increases the MOF basicity. This basicity improves interaction between the MOF framework and acid gases such as CO2. Although amine pendent groups are demonstrated in the MOF structures, other polar, especially basic, pendent groups will improve CO2 MOF interactions in the membrane. Other pendent groups may include nitriles and ethers.

In a representative synthesis, 7 mL ethanol and 7 mL diethylformamide were combined and 0.63 g (2.1 mmol) indium(III) nitrate hydrate added and mixed until dissolved. In a separate container, 0.29 g (1.56 mmol) terephthalic acid and 0.26 g (1.56 mmol) 2-aminoterephthalic acid were dissolved in a mixture of 7 mL ethanol and 7 mL diethylformamide. The two solutions were combined in a 45 mL teflon-line reactor, sealed and placed in a 130° C. oven for 3 days. After quenching, reactor contents were poured into a centrifuge tube and spun for 10 minutes at 10,000 rpm, decanted, washed three times by resuspending in 25 mL acetone, centrifuging as before and decanting. Final solids were collected and dried at 70° C.

### MOF-5

MOF-5 forms from a chemistry that is similar to MOF-4, however, MOF-5 contains ligands having and does not contain a pendent amine group which adds basicity to the MOF. This basicity improves interaction between the MOF framework and acid gases such as CO₂. Although amine pendent groups are demonstrated in the MOF structures, other polar, especially basic, pendent groups will improve CO₂ MOF interactions in the membrane. Other pendent groups may include nitriles and ethers.

In a representative synthesis, 7 mL ethanol and 7 mL diethylformamide were combined and 0.63 g (2.1 mmol) indium(III) nitrate hydrate added and mixed until dissolved. In a separate container, 0.57 g (3.1 mmol) terephthalic acid was dissolved in a mixture of 7 mL ethanol and 7 mL diethylformamide. The two solutions were combined in a 45 mL teflon-line reactor, sealed and placed in a 130° C. oven for 3 days. After quenching, reactor contents were poured into a centrifuge tube and spun for 10 minutes at 10,000 rpm, decanted, washed three times by resuspending in 25 mL acetone, centrifuging as before and decanting. Final solids were collected and dried at 70° C.

### Sample Preparation and Testing

Solution casting: C2C-18 was dissolved in 20 mL of chloroform. Once dissolved a predetermined amount of MOF was added to the solution. Solution was allowed to mix around 2 hr, or until MOF particles were no longer visible in the solution. Solution was then poured into a level, clean, dry 100 mm diameter Teflon casting plate and covered with a second interlocking Teflon casting plate to slow chloroform evaporation. Solutions could take from 1 to 3 days to dry.

### Pure Gas Testing Apparatus and Procedure

Apparatus: Obtain a gas permeation cell (Stainless Steel In-Line Filter Holder, 47 millimeters (mm), catalog number XX45 047 00 from Millipore Corporation). The gas permeation cell comprises a horizontal metal mesh support and a spaced-apart inlet and outlet respectively above and below the metal mesh support. The gas permeation cell together with a plaque being disposed on the metal mesh support, defines an upstream volume and a downstream volume. The inlet is in sequential fluid communication with the upstream volume, entrance face of the plaque, exit face of the plaque, downstream volume, and outlet. Also obtain a constant-volume variable-pressure pure gas permeation apparatus as schematically similar to that described in reference FIG. 7.109 of Wiederhorn, S., et al., Mechanical Properties in Springer-Handbook of Materials Measurement Methods; Czichos, H., Smith, L. E., Saito, T., Eds.; Springer: Berlin, 2005; pages 371-397. All samples were exposed to vacuum for at least 16 hours at 20° C. prior to testing. After vacuum, a leak rate was determined by closing both the upstream and downstream volumes to vacuum and feed gases. The rate of pressure increase was determined over a period of 5 minutes after the cell had been isolated for at least one hour. Acceptable leak rates were approximately 2×10⁻⁵ torr/s or below. After an acceptable leak rate had been obtained, the samples were exposed to N₂ at 15 psig until the rate of pressure increase had reached steady state (i.e., less than 0.5% change in pressure increase over a period of at least 10 minutes, but typically longer). An additional pressure of 45 psig was tested for permeation values at steady state. N₂, ethylene, and CO₂ steady state permeation values at 15, and 45 psig were obtained using the test method described for N₂. Between gases the upstream and downstream volumes were evacuated using a vacuum pump for at least 16 hours at 20° C.

### Example 1-5

TABLE 1
Gas Transport properties of 10 wt % MOF in PEA-C2C18% at upstream
pressure of 15 psig, and 35° C.

| | | CO₂ | N₂ | CH₄ | CO₂/N₂ | CO₂/CH₄ |
|---|---|---|---|---|---|---|
| Example | MOF | permeability, | permeability, | permeability, | ideal | ideal |
| number | Sample | barrer | barrer | barrer | selectivity | selectivity |
| Example 1 | MOF-1 | 33.4 | 0.9 | — | 38.9 | — |
| Example 2 | MOF-2 | 49.8 | 2.1 | 5.6 | 23.4 | 8.9 |
| Example 3 | MOF-3 | 79.3 | 3.1 | 8.4 | 25.6 | 9.4 |
| Example 4 | MOF-4 | 83.2 | 3.3 | 8.2 | 25.2 | 10.2 |
| Example 5 | MOF-5 | 98.0 | 4.1 | 8.9 | 24.0 | 11.0 |
| Counter | None | 19.5 | 0.3 | 1.2 | 62.9 | 16.8 |
| Example 1 | | | | | | |

### Example 6

Table 2 presents the Examples 6A and 6B and the Counter Example 1.

| Sample | Composition |
|---|---|
| Example 6A | PEA-C2C18% + 14 wt % MOF-1 |
| Example 6B | PEA-C2C18% + 20 wt % MOF-1 |
| Counter Example 1 | PEA-C2C18% |

TABLE 3
Pure gas permeability at 20° C. for Example 6A.

Permeability, barrer

| Gas | 15 psig | 45 psig |
|---|---|---|
| N₂ | 0.86 | 0.93 |
| C₂H₄ | 7.42 | Not Tested |
| CO₂ | 33.6 | 36.4 |

TABLE 4
Pure gas permeability at 20° C. for Example 6B.

Permeability, barrer

| Gas | 15 psig | 45 psig |
|---|---|---|
| N₂ | 1.49 | 0.93 |
| C₂H₄ | 11.68 | 13.44 |
| CO₂ | 49.4 | 53.5 |

TABLE 5
Pure gas permeability at 20° C. for Counter Example 1.

Permeability, barrer

| Gas | 15 psig | 45 psig |
|---|---|---|
| N₂ | 0.31 | 0.39 |
| C₂H₄ | 4.77 | 5.12 |
| CO₂ | 19.5 | 21.1 |

Table 3 shows the pure gas permeability of N₂, ethylene and CO₂ in Example 6A. Table 4 shows the CO₂ and ethylene pure gas permeability in Example 6B. Table 5 shows the pure gas permeability of N₂, ethylene and CO₂ in the Counter Example 1. Both materials exhibit increasing CO₂ permeability with increasing CO₂ upstream pressure, which is expected given the high solubility of CO₂ in polar polymers. Example 6A has approximately ˜80% higher permeability for CO₂ and ethylene than the Counter Example 1. N₂ permeability in Example 6A is over 3× higher than in the Counter Example 1.

Table 6 shows the CO₂/N₂ ideal gas selectivity at the two pressures.

| Sample | 15 psig | 45 psig |
|---|---|---|
| Counter Example 1 | 1.49 | 54.1 |
| Example 6A | 39.1 | 39.3 |
| Example 6B | 33.2 | 38.5 |

TABLE 7
“Pure gas CO₂/C₂H₄ selectivity at 20° C.”

| Sample | 15 psig | 45 psig |
|---|---|---|
| Counter Example 1 | 4.1 | 4.1 |
| Example 6A | 4.5 | Not tested |
| Example 6B | 4.2 | 4.0 |

Table 7 shows the CO₂/C₂H₄ selectivity for the Counter Example 1, Example 6A, and Example 6B.

While the invention has been described above according to its preferred embodiments of the present invention and examples of steps and elements thereof, it may be modified within the spirit and scope of this disclosure. This application is therefore intended to cover any variations, uses, or adaptations of the instant invention using the general principles disclosed herein. Further, this application is intended to cover such departures from the present disclosure as come within the known or customary practice in the art to which this invention pertains and which fall within the limits of the following claims.

The claimed invention is:

1. A membrane for separation of gases, said membrane comprising a metal-organic phase and a polymeric phase, said metal-organic phase comprising porous crystalline metal compounds and ligands, said polymeric phase comprising a molecularly self assembling polymer.

2. The membrane of claim 1, wherein the metal-organic phase comprises from about 1 weight percent (wt %) to about 70 wt % of the polymer MOF composite based on total weight of the polymer MOF composite.

3. The membrane of claim 1, wherein said metal organic phase comprises transition metal or metalloid compounds wherein said transition metal or metalloid is selected from the group consisting of Scandium, Titanium, Vanadium, Chromium, Manganese, Magnesium, Cobalt, Iron, Nickel, Copper, Zinc, Yttrium, Zirconium, Niobium, Molybdenum, Ruthenium, Rhodium, Palladium, Silver, Cadmium, Lanthanum, Hafnium, Tantalum, Tungsten, Rhenium, Osmium, Iridium, Gold, Indium, Aluminum, Lead, Tin, Gallium, Germanium, Bismuth, Polonium and mixtures thereof.

4. The membrane of any of the previous claims, wherein said metal-organic phase comprises a transition metal selected from the group consisting of Aluminum, Indium, Nickel, Zinc, and mixtures thereof.

5. The membrane of any of the previous claims, wherein said ligand is selected from the group of selected from the group of a bidentate ligand, a tridentate ligand, a macrocyclic ligand, and mixtures thereof.

6. The membrane of any of the previous claims, wherein said ligand is selected from the group of a dicarboxylic acid, dianhydrides, diimides, substituted dicarboxyic acids, disubstituted amines, disubstituted cycloamines, imidazoles, and mixtures thereof.

7. The membrane of any of the previous claims, wherein said ligand is selected from the group of terephthalic acid, 1,4-diazobicyclo(2,2,2)octane, 2-aminoterephthalic acid, 2-methylimidazole and mixtures thereof.

8. The membrane of any of the previous claims, wherein the molecularly self-assembling polymer material is selected from the group consisting of a polyester-amide, polyether-amide, polyester-urethane, polyether-urethane, polyether-urea, polyester-urea, and a mixture thereof.

9. The membrane of claim 8, wherein the molecularly self-assembling material comprises self-assembling units comprising multiple hydrogen bonding arrays.

10. The membrane of claim 9, wherein the multiple hydrogen bonding arrays have an association constant K(assoc) of greater than 10³ M⁻¹.

11. The membrane of claim 9, wherein the multiple H bonding arrays comprise at least 4 donor-acceptor hydrogen bonding sites per self-assembling unit.

12. The membrane of claim 9, wherein the multiple H bonding arrays comprise an average of 2 to 8 donor-acceptor hydrogen bonding sites per self-assembling unit.

13. The membrane of any one of the preceding claims, wherein the molecularly self-assembling material comprises repeat units of formula I: 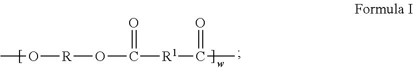
and at least one second repeat unit selected from the ester-amide units of Formula II and 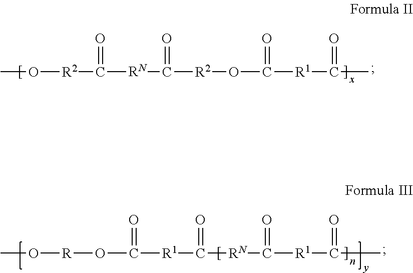
and the ester-urethane units of Formula IV: 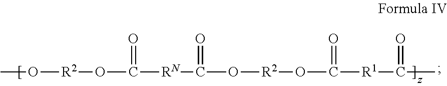
or combinations thereof wherein:
R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 grams per mole to about 15000 grams per mole;
R¹ at each occurrence independently is a bond or a C₁-C₂₀ non-aromatic hydrocarbylene group;
R² at each occurrence independently is a C₁-C₂₀ non-aromatic hydrocarbylene group;
R^{N} is —N(R³)—Ra—N(R³)—, where R³ at each occurrence independently is H or a C₁-C₆ alkylene and Ra is a C2-C20 non-aromatic hydrocarbylene group, or R^{N} is a C₂-C₂₀ heterocycloalkyl group containing the two nitrogen atoms, wherein each nitrogen atom is bonded to a carbonyl group according to formula (III) above; n is at least 1 and has a mean value less than 2; and w represents the ester mol fraction of Formula I, and x, y and z represent the amide or urethane mole fractions of Formulas II, III, and IV, respectively, where w+x+y+z=1, and 0<w<1, and at least one of x, y and z is greater than zero but less than 1.

14. The membrane of any of the previous claims, wherein the MSA material is a polymer or oligomer of Formula II or III: 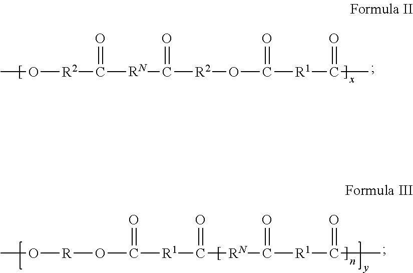
wherein
R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 grams per mole to about 5000 grams per mole;
R¹ at each occurrence independently is a bond or a C₁-C₂₀ non-aromatic hydrocarbylene group;
R² at each occurrence independently is a C₁-C₂₀ non-aromatic hydrocarbylene group;
R^{N} is —N(R³)—Ra—N(R³)—, where R³ at each occurrence independently is H or a C₁-C₆ alkylene and Ra is a C₂-C₂₀ non-aromatic hydrocarbylene group, or RN is a C₂-C₂₀ heterocycloalkyl group containing the two nitrogen atoms, wherein each nitrogen atom is bonded to a carbonyl group according to formula (III) above; n is at least 1 and has a mean value less than 2; and x and y represent mole fraction wherein x+y=1, and 0<x<1, and 0<y<1.

15. The membrane of claim 8, wherein the number average molecular weight (Mn) of the molecularly self-assembling material is between about 1000 grams per mole (g/mol) and about 100,000 g/mol.

16. The membrane of claim 15, wherein the Mn of the molecularly self-assembling material is less than 5,000 g/mol.

17. The membrane of claim 5, wherein the ligand has an amine functional group.

18. The membrane of claim 17, wherein said amine functional group is unreacted.

19. The membrane of claim 17, wherein said amine functional group is reacted.

20. A method of extracting an acidic gas from a gas stream through a membrane, said membrane comprising a metal-organic phase and a polymeric phase, said metal-organic phase comprising porous crystalline metal compounds and ligands, said polymeric phase comprising a molecularly self assembling polymer said method comprising the steps of:
a.) contacting said gas mixture with said membrane; and
b.) extracting said acidic gases from said gas stream.
wherein the permeability of the acid gas is generally at least about 30 and the acid gas/non polar gas selectivity is at least about 6.
